(19) United States
(12) Patent Application Publication
(10) Pub. No.: US 2015/0129039 A1
(43) Pub. Date: May 14, 2015

(54) Beverage Maker with Capacitance Fluid Level Sensor

(71) Applicant: Hamilton Beach Brands, Inc., Glen Allen, VA (US)

(72) Inventor: Patrick T. Mulvaney, Richmond, VA (US)

(73) Assignee: Hamilton Beach Brands, Inc., Glen Allen, VA (US)

(21) Appl. No.: 14/077,767

(22) Filed: Nov. 12, 2013

(51) Int. Cl. A47J 31/56

(52) U.S. Cl. CPC A47J 31/56
USPC 137/1; 99/280

(57) ABSTRACT

A beverage maker comprises a reservoir for holding a variable volume of a fluid, a pump or hot water generator for pumping the fluid out of the reservoir, a fluid-level sensor, and a controller operatively connected to the pump and the sensor. The controller is configured for determining, in conjunction with the sensor, a level of fluid in the reservoir at an initial time. The controller is further configured for causing the pump or hot water generator to operate for any one of a plurality of different amounts of time to motivate a same volume of water, each of the plurality of different amounts of time corresponding to a different level of fluid in the reservoir at the initial time.

### SUMMARY OF THE DISCLOSURE

The present invention relates generally to appliances, and more particularly to a kitchen appliance for preparing a beverage.

### BACKGROUND OF THE DISCLOSURE

Kitchen appliances for preparing a beverage are well known. Conventional beverage makers often have a fresh water reservoir. Fresh water is moved from the fresh water reservoir to use for making a beverage, such as coffee, tea, or hot chocolate. In some types of conventional beverage makers, moved from the fresh water reservoir until the reservoir is empty. That is, the entire volume of water in the fresh water reservoir consumed during a brew cycle. In such a beverage maker, a user must be careful to fill the fresh water reservoir with only the volume of water needed to make the desired type and/or volume of beverage.

In other types of conventional beverage makers, a specified volume of fresh water (which may be less than the entire volume in the fresh water reservoir) is removed from the fresh water reservoir as needed to make the desired type and/or volume of beverage. In such a beverage maker, a user may fill the fresh water reservoir with a large volume of water that may be used to make several beverages during distinct brew cycles. For example, a fresh water reservoir may have a sixty-ounce capacity and may only contain fifty ounces of water. A user may select, via a control panel on the beverage maker, to brew twelve ounces of coffee. During operation, the beverage maker would consume only the twelve ounces of water from the fresh water reservoir.

In a conventional beverage maker that is capable brewing a specified volume of fresh water from the fresh water reservoir, some means of measuring the volume of water to be brewed is necessary. It is well known to pump fresh water out of the fresh water reservoir into another reservoir, to measure the volume in that other reservoir while the fresh water is being pumped out of the fresh water reservoir, and to stop the pumping of fresh water out of the fresh water reservoir when the volume in the other reservoir has reached the specified volume of fresh water needed to make the desired type and/or volume of beverage. The volume of fresh water in the other reservoir is typically measured by detecting the water level in the other reservoir using fluid level probes or a float-type fluid sensor. However, fluid level probes only provide discreet measuring points without any variability in between the probe points. Float-type sensors are relatively expensive and potentially unreliable. In any event, such a separate reservoir used to measure the volume of fresh water from the fresh water reservoir may be unnecessary, such as in a conventional automatic drip coffeemaker. As such, finding a different means to meter the water from the fresh water reservoir could overcome the above and other disadvantages with conventional mechanisms while providing additional utility and flexibility in a wider range of brewed beverage makers.

The device of the following disclosure accomplishes the above and other objectives and overcomes at least the above-described disadvantages of conventional kitchen appliances.

### BRIEF SUMMARY OF THE DISCLOSURE

Briefly stated, one aspect of the present disclosure is directed to a beverage maker including a reservoir for holding a variable volume of a fluid, a pump or hot water generator (HWG) for motivating the fluid out of the reservoir, a fluid-level sensor, and a controller operatively connected to the pump and the sensor. The controller is configured for determining, in conjunction with the sensor, a level of fluid in the reservoir at an initial time. The controller is further configured for causing the pump or HWG to operate for any one of a plurality of different amounts of time to motivate a desired volume of water, each of the plurality of different amounts of time corresponding to a different level of fluid in the reservoir at the initial time.

Determining a level of fluid in the reservoir at an initial time may comprise determining which one of a plurality of predefined ranges of fluid levels the level of fluid in the reservoir falls within at the initial time.

The beverage maker may further comprise a riser tube in fluid communication with the reservoir such that a level of the fluid in the riser tube corresponds to a level of the fluid in the reservoir. The controller and sensor may determine the level of fluid in the reservoir by determining the level of fluid in the riser tube.

The sensor may comprise a capacitive sensor affixed to the riser tube. The capacitive sensor may comprise one or more capacitive plates affixed to the riser tube.

The controller may be further configured for determining a time to charge the capacitive sensor and/or a time to discharge the capacitive sensor. The time to charge the capacitive sensor and/or the time to discharge the capacitive sensor may correspond to a level of fluid in the riser tube.

The controller may be further configured for determining a time to perform a plurality of charge/discharge cycles of the capacitive sensor. The time to perform the plurality of charge/discharge cycles of the capacitive sensor may correspond to a level of fluid in the riser tube.

The controller may be further configured for determining a time to perform a plurality of charge/discharge cycles of the capacitive sensor. An average of the time to perform the plurality of charge/discharge cycles of the capacitive sensor may correspond to a level of fluid in the riser tube.

The controller may be further configured for determining a time to perform each of a plurality of groups of charge/discharge cycles of the capacitive sensor, each of the plurality of groups comprising a plurality of charge/discharge cycles of the capacitive sensor. An average of the time to perform each of the plurality of groups of charge/discharge cycles of the capacitive sensor may correspond to a level of fluid in the riser tube.

The controller may be configured for determining a capacitance of the capacitive sensor. The capacitance of the capacitive sensor may correspond to a level of fluid in the riser tube.

The controller may be further configured for determining a capacitance of the capacitive sensor a plurality of times. An average of the capacitance of the capacitive sensor determined a plurality of times may correspond to a level of fluid in the riser tube.

Another aspect of the present disclosure is directed to a beverage maker including a reservoir for holding a variable volume of a fluid, a pump or HWG for motivating the fluid out of the reservoir, a capacitive fluid-level sensor, and a controller operatively connected to the pump and the sensor. The controller is configured for determining, in conjunction with the sensor, a level of fluid in the reservoir at an initial time. The controller is further configured for causing the pump or HWG to operate for a first amount of time in order to motivate a desired volume of water when the level of fluid in the reservoir at the initial time comprises a first initial level. The controller is further configured for causing the pump or HWG to operate for a second amount of time different than the first amount of time in order to pump the desired volume of water when the level of fluid in the reservoir at the initial time comprises a second initial level different than the first initial level.

The controller may be further configured for causing the pump or HWG to operate for a third amount of time different than the first amount of time and different than the second amount of time in order to motivate the desired volume of water when the level of fluid in the reservoir at the initial time comprises a third initial level different than the first initial level and different that the second initial level.

Wherein determining a level of fluid in the reservoir at an initial time comprises determining which one of a plurality of predefined ranges of fluid levels the level of fluid in the reservoir falls within at the initial time.

The beverage maker may further comprise a riser tube in fluid communication with the reservoir such that a level of the fluid in the riser tube may correspond to a level of the fluid in the reservoir. The controller and sensor may determine the level of fluid in the reservoir by determining the level of fluid in the riser tube.

The sensor may comprise a capacitive sensor affixed to the riser tube, the capacitive sensor comprising one or more capacitive plates affixed to the riser tube.

The controller may be further configured for determining a time to charge the capacitive sensor and/or a time to discharge the capacitive sensor. The time to charge the capacitive sensor and/or the time to discharge the capacitive sensor may correspond to a level of fluid in the riser tube.

The controller may be further configured for determining a time to perform a plurality of charge/discharge cycles of the capacitive sensor. The time to perform the plurality of charge/discharge cycles of the capacitive sensor may correspond to a level of fluid in the riser tube.

The controller may be further configured for determining a time to perform a plurality of charge/discharge cycles of the capacitive sensor. An average of the time to perform the plurality of charge/discharge cycles of the capacitive sensor may correspond to a level of fluid in the riser tube.

The controller may be further configured for determining a time to perform each of a plurality of groups of charge/discharge cycles of the capacitive sensor, each of the plurality of groups comprising a plurality of charge/discharge cycles of the capacitive sensor. An average of the time to perform each of the plurality of groups of charge/discharge cycles of the capacitive sensor may correspond to a level of fluid in the riser tube.

The controller may be further configured for determining a capacitance of the capacitive sensor. The capacitance of the capacitive sensor may correspond to a level of fluid in the riser tube.

The controller may be further configured for determining a capacitance of the capacitive sensor a plurality of times. An average of the capacitance of the capacitive sensor determined a plurality of times may correspond to a level of fluid in the riser tube. Another aspect of the present disclosure is directed to a method of moving a desired volume of fluid from a reservoir of a beverage maker including determining a level of fluid in the reservoir at an initial time and motivating said water through the system for any one of a plurality of different amounts of time to move the same volume of water from the reservoir. Each of the plurality of different amounts of time correspond to a different level of fluid in the reservoir at the initial time.

Determining a level of fluid in the reservoir at an initial time may comprise determining which one of a plurality of predefined ranges of fluid levels the level of fluid in the reservoir falls within at the initial time.

Determining a level of fluid in the reservoir may comprise determining a level of fluid in a riser tube that is in fluid communication with the reservoir such that a level of the fluid in the riser tube may correspond to a level of the fluid in the reservoir.

The method may further comprise determining a time to charge a capacitive sensor affixed to the riser tube and/or a time to discharge the capacitive sensor. The time to charge the capacitive sensor and/or the time to discharge the capacitive sensor may correspond to a level of fluid in the riser tube.

The method may further comprise determining a time to perform a plurality of charge/discharge cycles of a capacitive sensor affixed to the riser tube. The time to perform the plurality of charge/discharge cycles of the capacitive sensor may correspond to a level of fluid in the riser tube.

The method may further comprise determining a time to perform a plurality of charge/discharge cycles of the capacitive sensor. An average of the time to perform the plurality of charge/discharge cycles of the capacitive sensor may correspond to a level of fluid in the riser tube.

The method may further comprise determining a time to perform each of a plurality of groups of charge/discharge cycles of a capacitive sensor affixed to the riser tube, each of the plurality of groups comprising a plurality of charge/discharge cycles of the capacitive sensor. An average of the time to perform each of the plurality of groups of charge/discharge cycles of the capacitive sensor may correspond to a level of fluid in the riser tube. The method may further comprise determining a capacitance of a capacitive sensor affixed to the riser tube. The capacitance of the capacitive sensor may correspond to a level of fluid in the riser tube. The method may further comprise determining a capacitance of a capacitive sensor affixed to the riser tube a plurality of times. An average of the capacitance of the capacitive sensor determined a plurality of times may correspond to a level of fluid in the riser tube.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1A is a perspective view of certain components of a capacitance fluid level sensor according to one embodiment of the present disclosure;

FIG. 1B is a top view thereof;

FIG. 1C is an alternative embodiment thereof;

FIG. 2 is a schematic diagram of certain components of a capacitance fluid level sensor according to one embodiment of the present disclosure;

FIG. 3 is a schematic diagram of certain portions of a kitchen appliance that may use a capacitance fluid level sensor according to an embodiment of the present disclosure;

FIG. 4 is a schematic diagram of certain components of the kitchen appliance that may use a capacitance fluid level sensor according to another embodiment of the present disclosure;

FIG. 5 is a schematic diagram of certain components of the kitchen appliance that may use a capacitance fluid level sensor according to another embodiment of the present disclosure; and

FIG. 6 is a further schematic diagram of one embodiment of the subject disclosure.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

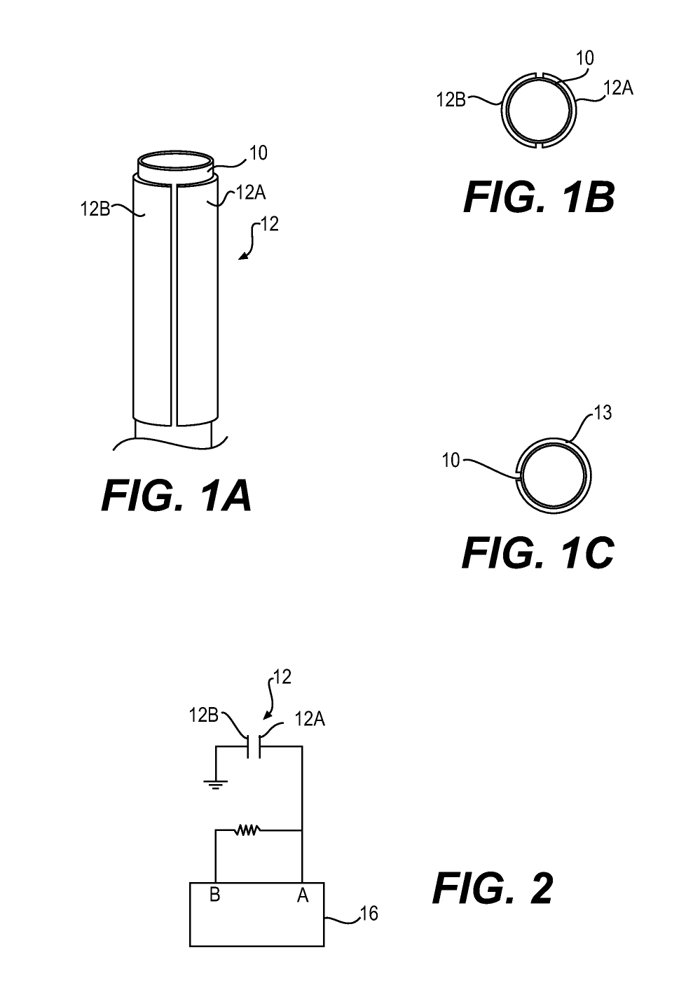

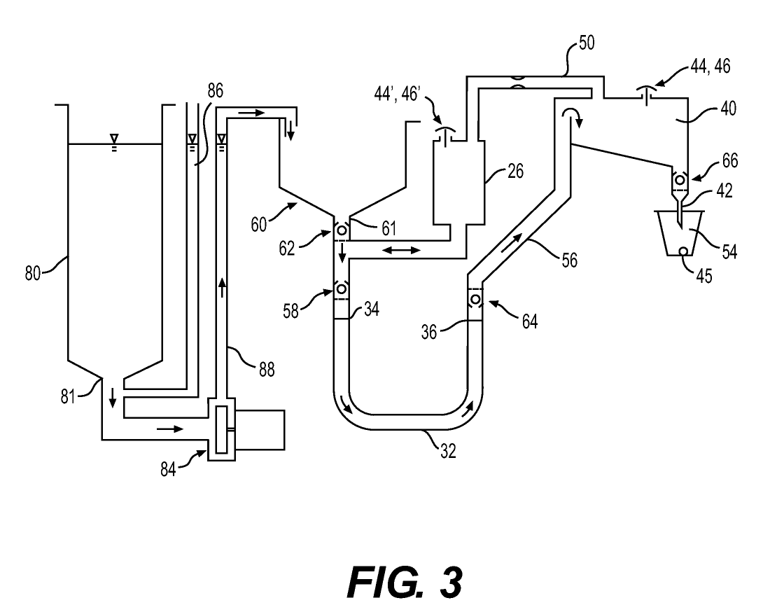

Referring to the drawings in detail, wherein like numerals indicate like elements throughout, FIGS. 1 and 2A illustrate a perspective and top view, respectively, of certain components of a capacitance fluid level sensor according to one embodiment of the present disclosure. The capacitance fluid level sensor may be used in any suitable kitchen appliance, such as the beverage makers illustrated in FIGS. 3-5 of the present disclosure or any of the beverage makers described in co-pending U.S. application Ser. No. 13/949,394, filed Jul. 24, 2013 and any related applications thereof, said applications being herein incorporated in their entirety by reference.

The subject capacitance fluid level sensor may be used in any kitchen appliance in which it is desirable to move a desired volume of fluid from a reservoir. The reservoir may be a fresh water reservoir, a brewed beverage reservoir, or the like. The fluid may be moved from the reservoir to any desired secondary location, including but not limited to a second reservoir (defined herein as a body, cavity, or conduit that holds a volume of liquid, either temporarily or for an extended period of time), or a showerhead or other outlet. For example, the second reservoir may be a holding tank for accumulating the desired amount of fluid prior to transmitting the fluid to a hot water generator or other fluid heating element. As another example, the second reservoir may be a hot water generator (HWG) through which the fluid flows to be heated. In yet another example, the second reservoir may be a hot water reservoir or a “showerhead.”

A kitchen appliance in which embodiments of the present disclosure may operate is intended or designed for preparing a beverage from foodstuff to be consumed by a user. The present disclosure is not limited by the type of beverage prepared by the kitchen appliance or foodstuff used to prepare the beverage. For example, the term “foodstuff,” as used herein, is sufficiently broad to cover any extractible/infusible substance, such as coffee grounds, tea leaves, hot chocolate powder, soup ingredients, oatmeal and the like. Thus, a kitchen appliance in which embodiments of the present disclosure may operate is versatile because it may be capable of being used to create and/or prepare any one of a variety of different types of beverages from a variety of different types of foodstuff. More specifically, a kitchen appliance in which embodiments of the present disclosure may operate preferably heats liquid, such as water, to a sufficient temperature to be combined with or poured over the foodstuff to create a hot beverage. The term “beverage” is broadly defined herein as hot water or a combination of liquid and foodstuff.

A kitchen appliance in which embodiments of the present disclosure may operate is versatile because it may allow a user to create a beverage from foodstuff in any one of a variety of different forms or states. For example, a kitchen appliance in which embodiments of the present disclosure may operate may be used to make coffee or tea from loose coffee grounds or leaves, coffee grounds or leaves contained in a generally soft packet (i.e., a flexible coffee “pod” or a tea bag), or coffee grounds or tea leaves contained in a generally hard container (i.e., a rigid coffee or tea “pod”). The foodstuff is preferably inserted into at least a portion of the kitchen appliance. Following completion of preparation of the beverage, any moist or saturated foodstuff remaining in the kitchen appliance is preferably removed and either recycled or discarded.

A kitchen appliance in which embodiments of the present disclosure may operate can comprise a reservoir (such as reservoir 80 in FIG. 3) for holding a variable volume of a fluid and a means to motivate the fluid (such as pump 84 in FIG. 3) for moving the fluid out of the reservoir. As discussed above, the fluid may be fresh water and the reservoir may be a fresh water reservoir. A pump that is used in such a kitchen appliance will have an associated pump curve. A pump curve is a mathematical representation of the relationship between pump head (which may be measured, for example, in feet, inches, meters, centimeters, or millimeters) and pump capacity (which may be measured, for example, in gallons per minute, liters per minute, or cubic meters per hour). Pump head is the difference in height between the level of the fluid to be pumped and the height of the destination to which the fluid is to be pumped. As pump head increases the pump capacity decreases, and conversely as pump head decreases the pump capacity increases. Pump capacity determines the length of time a pump will need to operate to pump a desired volume of fluid. To pump a specific volume of fluid, a relatively high pump capacity means that the pump will need to operate for a relatively short period of time. Conversely, to pump the same specific volume of fluid, a relatively low pump capacity means that the pump will need to operate for a relatively longer period of time. Therefore, to pump a specific volume of fluid, a relatively low pump head means that the pump will need to operate for a relatively short period of time. Conversely, to pump the same specific volume of fluid, a relatively high pump head means that the pump will need to operate for a relatively long period of time.

In a kitchen appliance in which embodiments of the present disclosure may operate, it is typically desired to pump a specified volume of fluid or one or more different specified volumes of fluid depending on the amount of beverage to be made. For example, a user may be able to select a volume (e.g., eight ounces, twelve ounces, or sixteen ounces) of beverage to be made or a “size” (e.g., small, medium, or large) of beverage to be made (with each size corresponding to a specified volume; for example, small may correspond to eight ounces, medium may correspond to twelve ounces, and large may correspond to sixteen ounces). Such user-selectable choices are typically fixed and limited in number.

As discussed above, in some types of conventional beverage makers, water is pumped out of the fresh water reservoir until the reservoir is empty. In such a beverage maker, a user must be careful to fill the fresh water reservoir with only the volume of water needed to make the desire type and/or volume of beverage. In contrast, a kitchen appliance in which embodiments of the present disclosure may operate is able to pump a specified volume of fluid out of a reservoir, which may be less than the entire volume of fluid in the reservoir, as needed. Accordingly, a user may fill a fresh water reservoir (such as reservoir 80 in FIG. 3) with a large volume of water that may be used to make several beverages, with only the necessary volume pumped out each time a beverage is made.

Depending on the initial fill volume or the number and size of prior brew cycles, the level of fluid in the reservoir will vary. The volume of fluid in a reservoir and the level of fluid in the reservoir are related, but not identical, concepts. The level of fluid in a reservoir measures how high on the reservoir the fluid reaches. The volume in the reservoir corresponding to a specific level will vary depending on the geometry (shape, etc.) of the reservoir. Because the level of fluid in the reservoir may vary, the pump head may vary and therefore the pump capacity may vary. In accordance with the present disclosure, in order to more accurately determine how long to operate the pump in order to pump a desired volume of fluid, the level of fluid in the reservoir (which correlates to the pump head) may be determined.

One embodiment of a kitchen appliance for use with the present disclosure comprises a reservoir for holding a variable volume of a fluid, a pump for pumping the fluid out of the reservoir, a fluid-level sensor, and a controller operatively connected to the pump and the sensor. The controller is configured for determining, in conjunction with the sensor, a level of fluid in the reservoir at an initial time (i.e., prior to making a desired beverage). The controller is further configured for causing the pump to operate for different amounts of time to pump a desired volume of water. The amount of time that the pump is to operate corresponds to the level of fluid in the reservoir at the initial time, in addition to corresponding to the volume of fluid to be pumped.

Prior to pumping the fluid to make the desired type and amount of beverage, the controller and fluid level sensor determine the level of fluid in the reservoir. By knowing the physical relationship between the reservoir (e.g., reservoir 80 in FIG. 3) and the destination to which the fluid is to be pumped (e.g., second reservoir 60 in FIG. 3), the pump head is determined from the fluid level in the reservoir. By knowing the pump head, the pump capacity for that pump head is determined from the pump curve for the specific pump used in the kitchen appliance. By knowing the desired volume of fluid to be pumped (e.g., eight, twelve, or sixteen ounces) and the pump capacity at the determined pump head, the pump time to pump the desired volume of fluid is determined (pump time=volume to be pumped/pump capacity). Thus, the pump time for any specific desired volume will vary depending on the initial level in the reservoir. By varying the pump time for a specific desired volume based on the initial fluid level in the reservoir, the volume of fluid that is pumped will be more accurate (i.e., will be closer to the desired volume).

In one embodiment of the present disclosure, each of the above determinations (reservoir fluid level, pump head, pump capacity, and pump run time) could be made in real time for the desired volume of fluid to be pumped. In one preferred embodiment of the present disclosure, the controller may be pre-programmed with correlations between various fluid levels and the corresponding pump run time for each possible volume of fluid that may be desired to be pumped. As such, the controller would determine (in conjunction with the fluid level sensor) the fluid level and the desired volume of fluid to pump (typically, although not necessarily, based on user input), and then access the pre-programmed correlations to determine the required pump run time.

In one embodiment of the present disclosure, a number of correlations may be pre-programmed between various fluid levels and the corresponding pump run time for each possible volume of fluid that may be desired to be pumped. For example, a correlation may be pre-programmed for each incremental one millimeter of fluid level in the reservoir. As another example, a correlation may be pre-programmed for each fluid level that corresponds to an incremental one ounce of fluid volume in the reservoir. In this latter example, for a sixty ounce reservoir there may be sixty pre-programmed correlations. In such an embodiment in which a large but manageable number of correlations are pre-programmed between various fluid levels and the corresponding pump run time, if the fluid level determined by the controller and the sensor does not correspond to a fluid level of one of the pre-programmed correlations, then the controller will select the pre-programmed correlation for the closest fluid level to the fluid level determined by the controller and the sensor.

In one preferred embodiment of the present disclosure, the possible fluid levels in the reservoir are grouped into a plurality of predefined ranges of fluid levels. For example, for a sixty ounce reservoir, three fluid level ranges may be defined. One range may span from empty to the fluid level corresponding to twenty ounces, one range may span from the fluid level corresponding to twenty-one ounces to the fluid level corresponding to forty ounces, and one range may span from the fluid level corresponding to forty-one ounces to full. It should be appreciated that any desired number and/or span of ranges may be selected. In this preferred embodiment, correlations are pre-programmed between each of the plurality of predefined ranges of fluid levels and the corresponding pump run time for each possible volume of fluid that may be desired to be pumped. In operation of this preferred embodiment, the controller and fluid level sensor determine the level of fluid in the reservoir at the initial time. The controller then determines which one of the plurality of predefined ranges of fluid levels the determined level of fluid in the reservoir falls within. The controller then accesses the pre-programmed correlations to determine the required pump run time for the determined range. It is also possible to alert a user to add additional fluid to the reservoir.

For each range of fluid levels, a single fluid level within the range may be preselected as the fluid level that would be used to calculate the pump head, pump capacity, and pump run time for that range. The calculated pump run time for that single fluid level would be the pump run time stored in the pre-programmed correlations as the pump run time for that range. This selection of a single fluid level for each range to determine the pump run time for the range may be desirable because different fluid levels within the same range would result in different run times; however, a single pump run time for each range is desired for proper operation of the kitchen appliance. In one embodiment of the present disclosure, a fluid level in the middle of each range is selected as the fluid level that would be used to calculate the pump run time for that range.

Grouping the possible fluid levels in the reservoir into a plurality of predefined ranges of fluid levels and determining which one of the plurality of predefined ranges of fluid levels the determined level of fluid in the reservoir falls within (rather than trying to determine a precise fluid level) may be desirable in order to compensate for inaccuracies and/or inconsistencies in the fluid level detection. Such inaccuracies and/or inconsistencies in the fluid level detection would not be apparent in most circumstances when ranges of fluid levels are used. Such inaccuracies and/or inconsistencies are seldom going to result in an incorrect range being determined, because even an inaccurate and/or inconsistent fluid level determination will typically fall within the correct range except when the actual fluid level is close to the transition from one range to another range (and even then the inaccurate and/or inconsistent fluid level determination will often fall within the correct range). When the fluid level sensor comprises a capacitance fluid level sensor, as discussed below, such inaccuracies and/or inconsistencies may be a result of, for example, the humidity of the ambient air and/or fluid droplets remaining on the wall of the reservoir to which the capacitance fluid level sensor is affixed.

The controller and sensor may be configured for determining a level of fluid in the reservoir at times other than the initial time. For example, the controller and sensor may be configured for determining the fluid level while the pump is pumping, either continuously or at discrete time intervals.

The controller and sensor may be configured for determining the fluid level directly in the reservoir, such as by having the sensor affixed to or within the reservoir. Alternatively, the controller and sensor may be configured for indirectly determining the fluid level in the reservoir, such as by having the sensor affixed to or within a body, cavity, or conduit that is in fluid communication with the reservoir and which therefore has the same fluid level as the reservoir. For example, the fluid level sensor may be configured to determine the fluid level in a riser tube, such as riser tube 86 in FIG. 3, which is in fluid communication with reservoir 80, such that the level of the fluid in the riser tube corresponds to the level of the fluid in the reservoir. As another example, the fluid level sensor may be configured to determine the fluid level in a fill tube, such as fill tube 88 in FIG. 3, which is in fluid communication with reservoir 80, such that the level of the fluid in the fill tube corresponds to the level of the fluid in the reservoir. However, the fluid level in fill tube 88 will no longer be the same as the fluid level in reservoir 80 once the pump begins pumping fluid from the reservoir up the fill tube (i.e., fill tube 88 will be full of fluid during pumping, regardless of the fluid level in reservoir 80).

In addition to determining the fluid level in the reservoir for determining pump run time, the controller and sensor may be configured for determining the fluid level in the reservoir for other purposes. For example, the controller and sensor may be configured for determining the fluid level in the reservoir in order to determine if there is enough fluid in the reservoir to make the desired size of beverage prior to beginning the beverage making process.

The fluid level sensor comprises a capacitance fluid level sensor. Referring now to FIGS. 1A and 1B, perspective and top views, respectively, of certain components of a capacitance fluid level sensor are illustrated according to one embodiment of the present disclosure. The capacitance fluid level sensor can comprise two semi-cylindrically-shaped conductive plates 12a, 12b affixed to opposing sides of a generally cylindrical, generally vertical tube 10 that may contain variable amounts of a fluid. Together, conductive plates 12a, 12b comprise capacitor 12. The capacitance of capacitor 12 will depend on the size and shape of conductive plates 12a, 12b, the size and shape of tube 10, and the amount of fluid in tube 10. Tube 10 may comprise any suitable fluid reservoir that holds a variable amount of fluid and of which it is desired to determine the level. For example, tube 10 may comprise: a fresh water reservoir, such as reservoir 80 in FIG. 3; a riser tube such as riser tube 86 in FIG. 3, or a fill tube such as fill tube 88 in FIG. 3.

In one embodiment of the present disclosure, conductive plates 12a, 12b are of equal size and are uniformly spaced apart from each other along the entire height of the plates on both opposing sides. Conductive plates 12a, 12b may comprise any suitable conductive material, but in one embodiment of the present disclosure, conductive plates 12a, 12b each comprise an elongated segment of flexible printed circuit board material affixed to tube 10 using pressure sensitive adhesive (such as polyamine adhesive tape). Each elongated segment of flexible printed circuit board material comprises an elongated strip of a conductive material, such as copper. Although not illustrated in FIGS. 1A and 1B, conductive plates 12a, 12b are electrically connected to a controller as illustrated in FIG. 2.

Two conductive plates are not required or necessarily preferred. As illustrated in FIG. 1C, a single conductive plate 13 can be used. The capacitance of the plate 13 can vary based on the volume of fluid in tube 10. A single conductive plate can be more cost effective as well as more easily assembled.

Referring now to FIG. 2, a schematic diagram of certain components of a capacitance fluid level sensor and associated controller is illustrated according to one embodiment of the present disclosure. Optional conductive plate 12b is electrically grounded. Conductive plate 12a is electrically connected directly to pin A of controller 16 and indirectly connected to pin B of controller 16 through resistor 14 as part of a resistor-capacitor circuit.

Resistor 14 may comprise any suitable resistor, such as a 10 MΩ resistor. Controller 16 may comprise a microprocessor, dedicated or general purpose circuitry (such as an application-specific integrated circuit or a field-programmable gate array), a suitably programmed computing device, or any other suitable means for controlling the operation of the capacitance fluid level sensor (and typically also controlling the operation of the kitchen appliance of which the capacitance fluid level sensor is a component). Controller 16 is configured for charging and discharging conductive plate 12a as described in detail below. Controller 16 is also configured for determining how much time it takes to charge capacitor 12 from a first voltage to a second voltage, and/or for determining how much time it takes to discharge capacitor 12 from a third voltage to a fourth voltage, as described in detail below.

Permittivity is a measure of how an electric field affects, and is affected by, a dielectric medium. Air has a relatively small permittivity, while water has a relatively large permittivity. Because of this difference in permittivity adjacent plate 12a, the capacitance of the RC circuit will vary based on the level of fluid (e.g., water) in tube 10. Namely, because of this difference in capacitance based on the level of fluid in tube 10, the time to charge and/or discharge capacitor 12 will vary based on the level of fluid in tube 10. By measuring the time to charge and/or discharge capacitor 12, it is possible to determine the level of fluid in tube 10. As discussed above, determining the level of fluid enables determination of pump run time for any desired volume of fluid to be pumped.

After a kitchen appliance that uses a capacitance fluid level sensor of embodiments of the present disclosure has been designed (such that it is known which specific components will be used, the size and shape of the components, the relative positions of the components to each other, etc.), some preliminary determinations are made to enable operation of the kitchen appliance as described herein. Such preliminary determinations may be made analytically and/or empirically.

The capacitance of the RC circuit may be determined, using any suitable method of determining capacitance, when tube 10 is full of fluid (e.g., water or whatever fluid is to be pumped) and when tube 10 is empty. Once the capacitance is determined when tube 10 is full and when tube 10 is empty, it is possible to determine the capacitance at any fluid level between full and empty because there is a linear relationship between the capacitance when the tube is full and the capacitance when the tube is empty.

The determined capacitance at each level of fluid may be used to calculate the charge and discharge time (which are generally the same and which are referred to hereinafter as the charge/discharge time) of the RC circuit at each level of fluid. The time constant τ may be calculated using the formula τ=C*R, where τ is the charge/discharge time in seconds, C is capacitance in farads of capacitor 12, and R is resistance in ohms of resistor 14. By preliminarily calculating the time constant of the RC circuit at each fluid level, during operation of the kitchen appliance it is possible to determine the fluid level by measuring the charge and/or discharge time of the capacitor and comparing the measured charge and/or discharge time to the calculated charge/discharge time, as discussed in detail below.

In an alternative embodiment of the present disclosure, the capacitance and then the capacitor charge/discharge time are preliminarily determined for each of a plurality of ranges of fluid level. During operation of a kitchen appliance of such an alternative embodiment, it is possible to determine the fluid level range (which may be desirable as discussed above) by measuring the charge and/or discharge time of the RC circuit and comparing the measured charge and/or discharge time to the calculated charge/discharge time for each range. The capacitance and then the capacitor charge/discharge time may be preliminarily determined at the upper and lower ends of each range, such that the fluid level range is determined by comparing the measured charge and/or discharge time to the calculated charge/discharge times for the upper and lower ends of each fluid level range. Alternatively, the capacitance and then the RC circuit charge/discharge time may be preliminarily determined at the midpoint of each fluid level range, such that the fluid level range is determined by comparing the measured charge and/or discharge time to the calculated charge/discharge times for the midpoint of each fluid level range.

In an alternative embodiment of the present disclosure, the capacitance of capacitor 12 is not preliminarily determined, and the charge/discharge time of the RC circuit at each level of fluid is not preliminarily calculated based on the determined capacitance. Rather, the charge/discharge time of capacitor 12 is preliminarily determined empirically when tube 10 is full and when tube 10 is empty. Once the charge/discharge time is determined empirically when tube 10 is full and when tube 10 is empty, it is possible to analytically determine the charge/discharge time at any fluid level between full and empty because there is a linear relationship between the charge/discharge time when the tube is full and the charge/discharge time when the tube is empty. Further alternatively, the charge/discharge time at a plurality of fluid levels or a plurality of fluid level ranges may be preliminarily determined empirically. In such an alternative embodiment in which the charge/discharge time of the capacitor is preliminarily determined empirically, during operation of the kitchen appliance it is possible to determine the fluid level or fluid level range by measuring the charge and/or discharge time of the RC circuit and comparing the measured charge and/or discharge time to the empirically determined charge/discharge time for each fluid level or range of fluid levels.

Other factors that may be preliminarily determined once the design of the kitchen appliance is complete include pump head at each fluid level or range of fluid levels and pump run time at each fluid level or range of fluid levels for each desired volume of fluid to pump. In addition to the pre-programmed correlations between various fluid levels or ranges of fluid levels and the corresponding pump run time for each possible volume of fluid that may be desired to be pumped, as discussed above, for embodiments of the present disclosure in which a capacitance fluid level sensor is used it is desirable to further include pre-programmed correlations between capacitor charge and/or discharge times and various fluid levels or ranges of fluid levels. Having such pre-programmed correlations will enable a kitchen appliance of embodiments of the present disclosure to measure the charge and/or discharge time of the capacitor of a capacitance fluid level sensor (as discussed in detail below), determine the fluid level or range of fluid level based on the measured charge and/or discharge time, and determine the pump run time for a desired volume of fluid based on the determined fluid level or range of fluid level.

In a kitchen appliance of embodiments of the present disclosure, the charge time of the capacitor may be determined by applying five volts DC to pin A of controller 16 (which will over time charge the capacitor to five volts) and timing how long it takes for the charge at pin B of controller 16 to go from a first voltage (e.g., 2.5 volts) to a second voltage (e.g., 4.5 volts). The discharge time may be then determined by removing the five volt charge from pin A of controller 16 (which will over time discharge the capacitor) and timing how long it takes for the charge at pin B of controller 16 to go from a third voltage (e.g., 4.5 volts) to a fourth voltage (e.g., 2.5 volts). The first and fourth voltage will typically, although not necessarily, be the same voltage, and the second and third voltage will typically, although not necessarily, be the same voltage.

While embodiments of the invention are described herein as determining a charge and discharge time for the capacitor of a capacitance fluid level sensor, such charge and discharge times are typically very short (e.g., milliseconds). As such, measuring the time for a single charge or a single discharge of the capacitor is likely to be inaccurate and/or inconsistent given typical clock speeds of microprocessor-based devices such as controller 16. As such, in a preferred embodiment of the present disclosure, the charge and/or discharge time of the capacitor is measured a plurality of times. For example, a plurality of charge/discharge cycles may be measured, with either the total time of the plurality of charge/discharge cycles or an average time of the plurality of charge/discharge cycles being used as the measured charge/discharge time. In another example, a plurality of groups of charge/discharge cycles may each be measured, with an average of the total time for each group of charge/discharge cycles being used as the measured charge/discharge time. As a specific example, a total of 200 charge/discharge cycles may be measured in four groups of fifty cycles, and the times for each group may be averaged, with the average time for the four groups of fifty cycles being used as the measured charge/discharge time.

In an alternative embodiment of the disclosure, the capacitance of the capacitive sensor is determined and compared to the preliminarily determined capacitance of the capacitive sensor at each fluid level or range of fluid levels to determine the fluid level. Further alternatively, the capacitance of the capacitive sensor may be determined a plurality of times and an average of the capacitance of the capacitive sensor determined a plurality of times may be used to determine the fluid level.

In operation of a typical kitchen appliance of embodiments of the disclosure, such as the kitchen appliances illustrated in FIGS. 3-5, a user fills a fresh water reservoir with water to be used to make one or more beverages (e.g., coffee). The user may fill the fresh water reservoir immediately prior to making a beverage, or the user may have filled the fresh water reservoir some length of time prior to making a beverage. The user places the foodstuff (e.g., coffee grounds, coffee pod, or the like) used to prepare the beverage into the kitchen appliance. The user selects a size of beverage to make (e.g., eight ounce, twelve ounce, or sixteen ounce), and begins the beverage-making cycle (such as by pressing a “start” button). The kitchen appliance determines an initial level of water in the fresh water reservoir. In a preferred embodiment of the present disclosure, the kitchen appliance determines an initial level of water in the fresh water reservoir by way of a controller repeatedly charging and discharging the capacitor of a capacitance fluid level sensor affixed to a riser tube that is in fluid communication with the fresh water reservoir. The controller determines the charge/discharge time of the capacitor and compares the determined charge/discharge time to predetermined correlations between charge/discharge time and water level or range of water level in order to determine the current water level or water level range in the riser tube (which corresponds to the water level in the fresh water reservoir). The controller then compares the determined current water level or water level range to predetermined correlations between water level or water level range and pump run times for each of the possible volumes of water to be pumped in order to determine the appropriate pump run time for the volume of water needed to make the user-selected beverage size. The controller then causes the pump to operate for the determined pump run time, thereby causing the desired volume of water to be pumped from the fresh water reservoir.

Prior to beginning the beverage making process, the kitchen appliance may compare the determined initial water level to the desired beverage size to ensure there is enough water in the fresh water reservoir to make the desired beverage. If there is insufficient water in the fresh water reservoir, the kitchen appliance may alert the user, such as by way of a “low water level” indicator light or the like.

The path of the pumped fresh water after the water leaves the fresh water reservoir and what happens to the pumped fresh water varies depending on the type of kitchen appliance and specific design of the kitchen appliance. FIGS. 3-5 illustrate three examples of different types of kitchen appliances that may use a fluid level sensor or method of sensing fluid level of embodiments of the present disclosure. The kitchen appliances of FIGS. 3-5 are described herein merely to illustrate how different types of kitchen appliances may benefit from the fluid level sensor and method of sensing fluid level of embodiments of the present disclosure. The fluid level sensor and method of sensing fluid level of embodiments of the present disclosure are not limited to use in or with the kitchen appliances of FIGS. 3-5, but rather may be used in any suitable kitchen appliance in which it is desirable to pump a desired volume of fluid with increased accuracy.

Referring now to FIG. 3, a kitchen appliance is illustrated that is capable of operating in either of at least two operating modes, such as a non-pressurized (i.e., drip brew) mode and a pressurized mode. In such a non-pressurized mode, the kitchen appliance operates similar to a conventional automatic drip coffee maker (“ADC”). For example, in the non-pressurized mode, an internal pressure of the kitchen appliance 10 is generally maintained at or near atmospheric pressure (i.e., 1 atm=101.325 kPa=14.696 psi). In such a pressurized mode, an internal pressure of the kitchen appliance is raised to greater than ambient pressure during a brew or heat cycle, as explained further below.

The kitchen appliance of FIG. 3 comprises a fresh water reservoir 80 and an outlet 81 formed in a lower portion thereof. At least a portion of a bottom wall of the fresh water reservoir 80 may be slanted or sloped to direct liquid (e.g., water) toward the outlet 81. The outlet 81 of the fresh water reservoir 80 is fluidly connected to a third reservoir 60 in a manner to transmit fluid to the third reservoir but not vice versa. While it is preferred that the fresh water reservoir 80 is a generally closed container that is separable from the housing of the kitchen appliance, the fresh water reservoir 80 is preferably not air-tight, such that the fresh water reservoir 80 is maintained at atmospheric pressure. As described in detail above, a capacitance fluid level sensor (not illustrated in FIG. 3) is configured to determine the fluid level in riser tube 86, which corresponds to the fluid level in fresh water reservoir 80.

As shown in FIG. 3, a pump 84 is preferably positioned between and/or operatively connects the fresh water reservoir 80 and the third reservoir 60. A fill tube 88 preferably fluidly connects the pump 84 to the third reservoir 60. The pump 84 is not limited to being a certain type of pump, as the pump 84 may be a positive displacement pump, a water pump, or an air pump, for example. The pump 84 preferably forces liquid from the outlet 81 of the fresh water reservoir 80 into the third reservoir 60. The pump 84 can dispense or pump a user-chosen volume of liquid (e.g., small, medium or large) as determined by a time-based algorithm that varies depending on the initial level of water in the fresh water reservoir, as discussed in detail above.

The brew or heat cycle is then activated to brew/heat the entirety of the fluid in the third reservoir 60. Gravity moves liquid from the third reservoir 60 via an outlet 61 formed in a lower portion thereof, through the primary check valve 62 and into the T-connection of the first reservoir 26. Due to gravity, liquid will freely pass from the first reservoir 26, through the inlet check valve 58 and into the hot water generator (HWG) 32. Liquid will continue to move via gravity into and through the HWG 32 and into the riser tube 56. Liquid will pass through the outlet check valve 64 and continue upwardly in the riser tube 56 until the liquid reaches equilibrium with liquid in the third reservoir 60. For example, equilibrium may be reached when a level of liquid in the third reservoir 60 is generally equal to a level of liquid in the riser tube 56. The outlet check valve 64 prevents a vacuum created by the eventual phase change of gas (e.g., steam) to liquid (e.g., water) in the HWG 32 from drawing liquid from the riser tube 56 back into the HWG 32.

After a relatively short duration from when the pump 84 is first energized, the HWG 32 will be energized by a relay controlled by the controller 16. The HWG 32 then heats the liquid within the system and generates saturated gas bubbles. The gas bubbles increases the pressure of the liquid within the HWG 32 and act to move heated liquid within the HWG 32. Since the inlet check valve 58 prevents liquid from moving out of the HWG 32 and back into the first or third reservoirs 26, 60, heated liquid is forced out of the HWG 32, into the riser tube 56, and into the second reservoir 40.

In the pressurized mode (i.e., where discharge port 42 is restricted by a container/foodstuff), the pressure within the system increases. The pressure in the second reservoir 40 pushes liquid from the second reservoir 40 through the discharge check valve 66, the discharge port 42 and the container 54 (through hole 45) and into the vessel to be consumed by the user. At least some of the pressure and will pass through a fluid path 50 (opening or conduit) and into the first reservoir 26, which acts to equalize the pressure between the inlet end 34 and the outlet end 36 of the HWG 32. Shortly thereafter, gas in the HWG 32 will begin to condense and create a vacuum. The vacuum in the HWG 32, combined with the increased pressure in the first reservoir 26, will act to draw more liquid through the inlet check valve 58 into the HWG 32. The outlet check valve 64 prevents previously-heated liquid from reentering the HWG 32 from the riser tube 56.

After fluid leaves the HWG 32, gas in the fluid can begin to condensate because the gas is no longer subjected to the relatively high heat of the HWG 32. The condensation may create a vacuum in the riser tube 56 and/or the second reservoir 40. The discharge check valve 66 prevents foodstuff and/or gas in the drawer assembly (not illustrated) from being drawn into the second reservoir 40. The vacuum will pass through the conduit 50 and into the first reservoir 26. The vacuum in the first reservoir 26 will draw liquid from the third reservoir 60, through the primary check valve 62 and into the first reservoir 26. The movement of liquid from the third reservoir 60 into the first reservoir 26 will act to equalize, reduce or eliminate the vacuum.

The system will repeat or otherwise continue the above-described pressure/vacuum cycle until all liquid in the third reservoir 60 and the first reservoir 26 is consumed (i.e., passed through the discharge port). After all or substantially all fluid is forced out of the HWG 32, a temperature of the HWG 32 will increase until a thermostat or other mechanism (not shown) opens or otherwise terminates energy to the HWG 32. For example, a sensor (not shown) on a thermostat could signal the controller 16 to open a relay and terminate the current operating cycle. The drawer assembly can then slide out and/or be removed from the housing (not illustrated) of the kitchen appliance to either dispose of the spent container 54 and/or clean the drawer in preparation for a later operating cycle.

A pressure relief valve 44 and/or a separate vacuum release valve 46 may be positioned in or near a top wall of the second reservoir 40. The valves 44, 46 may be of a spring-loaded, umbrella type, or the like. The pressure relief valve 44 is preferably biased closed and preferably opens when a pressure within the second reservoir 40 reaches a predetermined value. The pressure relief valve 44 can prevent over-pressurization of the discharge port 42. The vacuum release valve 46 is preferably biased closed and preferably opens if and when a vacuum is created inside the second reservoir 40 or when the internal pressure drops below atmospheric. Similarly, a pressure relief valve 44′ and/or a separate vacuum release valve 46′ may be positioned in or near a top wall of the first reservoir 26. The valves 44′, 46′ may be of a spring-loaded, umbrella type, or the like. The pressure relief valve 44′ is preferably biased closed and preferably opens when a pressure within the first reservoir 26 reaches a predetermined value to prevent over-pressurization. The vacuum release valve 46′ is preferably biased closed and preferably opens if and when a vacuum is created inside the second reservoir 40 or when the internal pressure drops below atmospheric.

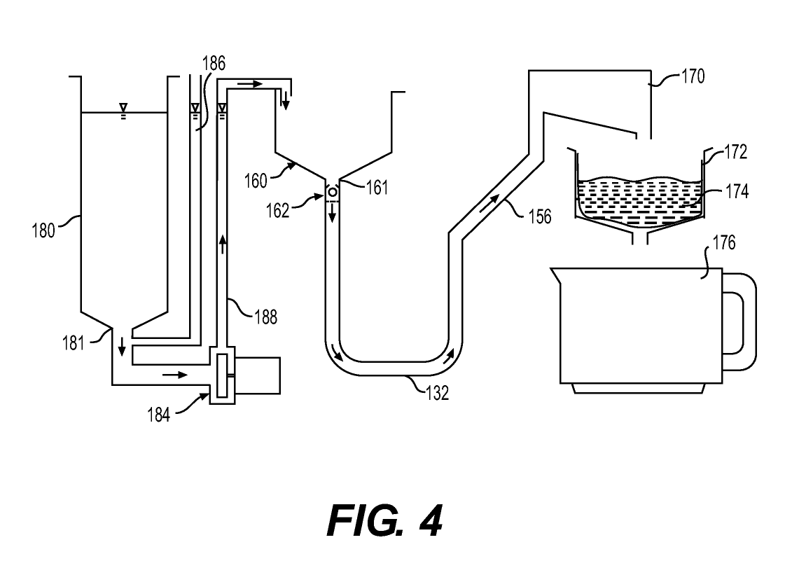

Referring now to FIG. 4, a kitchen appliance is illustrated that is capable of operating in a non-pressurized (i.e., drip brew) mode. The kitchen appliance of FIG. 4 comprises a fresh water reservoir 180 and an outlet 181 formed in a lower portion thereof. At least a portion of a bottom wall of the fresh water reservoir 180 may be slanted or sloped to direct liquid (e.g., water) toward the outlet 181. The outlet 181 of the fresh water reservoir 180 is fluidly connected to a third reservoir 160 in a manner to transmit fluid to the third reservoir but not vice versa. While it is preferred that the fresh water reservoir 180 is a generally closed container that is separable from the housing of the kitchen appliance, the fresh water reservoir 180 is preferably not air-tight, such that the fresh water reservoir 180 is maintained at atmospheric pressure. As described in detail above, a capacitance fluid level sensor (not illustrated in FIG. 4) is configured to determine the fluid level in riser tube 186, which corresponds to the fluid level in fresh water reservoir 180.

As shown in FIG. 4, a pump 184 is preferably positioned between and/or operatively connects the fresh water reservoir 180 and the second reservoir 160. A fill tube 188 preferably fluidly connects the pump 184 to the second reservoir 160. The pump 184 is not limited to being a certain type of pump, as the pump 184 may be a positive displacement pump, a water pump, or an air pump, for example. The pump 184 preferably forces liquid from the outlet 181 of the fresh water reservoir 180 into the second reservoir 160. The pump 184 can dispense or pump a user-chosen volume of liquid (e.g., small, medium or large) as determined by a time-based algorithm that varies depending on the initial level of water in the fresh water reservoir, as discussed in detail above.

The brew or heat cycle is then activated to brew/heat the entirety of the fluid in the second reservoir 160. Gravity moves liquid from the second reservoir 160 via an outlet 161 formed in a lower portion thereof, through the inlet check valve 162 and into the hot water generator (HWG) 132. Liquid will continue to move via gravity into and through the HWG 132 and into the riser tube 156.

After a relatively short duration from when the pump 184 is first energized, the HWG 132 will be energized by a relay controlled by the controller 16. The HWG 132 then heats the liquid within the system and generates saturated gas bubbles. The gas bubbles increases the pressure of the liquid within the HWG 132 and act to move heated liquid within the HWG 132. Since the inlet check valve 162 prevents liquid from moving out of the HWG 132 and back into the second reservoir 160, heated liquid is forced out of the HWG 132, into the riser tube 156, and into the first reservoir 170 (also termed a showerhead). From the showerhead 170, the heated liquid drips down onto coffee grounds 174 in the filter basket 172. Heated liquid infused by the coffee grounds exits the filter basket and drips into the carafe 176.

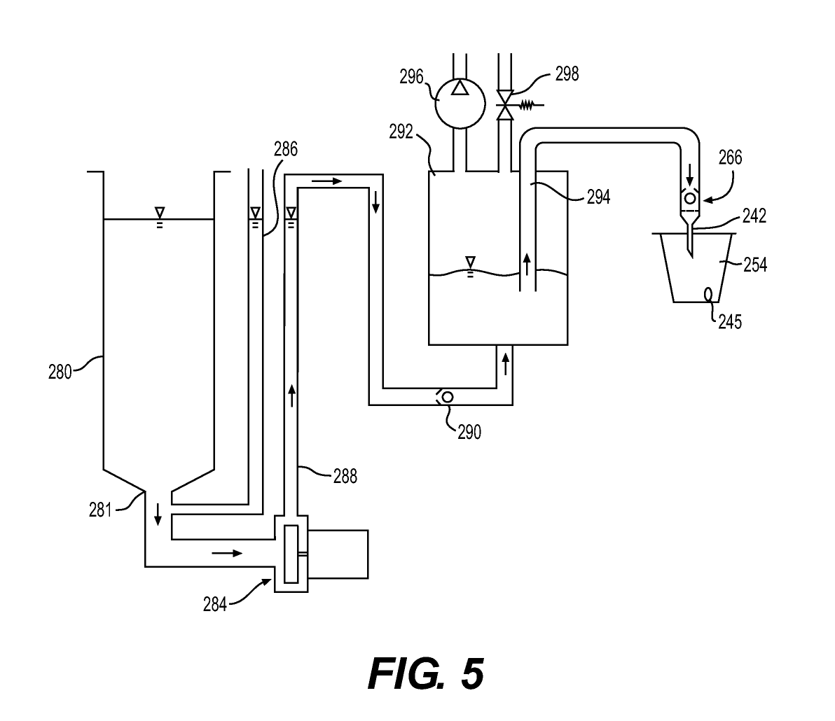

Referring now to FIG. 5, a kitchen appliance is illustrated that is capable of operating in a pressurized mode. The kitchen appliance of FIG. 5 comprises a fresh water reservoir 280 and an outlet 281 formed in a lower portion thereof. At least a portion of a bottom wall of the fresh water reservoir 280 may be slanted or sloped to direct liquid (e.g., water) toward the outlet 281. The outlet 281 of the fresh water reservoir 280 is fluidly connected to a boiler 292 in a manner to transmit fluid to the boiler but not vice versa. While it is preferred that the fresh water reservoir 280 is a generally closed container that is separable from the housing of the kitchen appliance, the fresh water reservoir 280 is preferably not air-tight, such that the fresh water reservoir 280 is maintained at atmospheric pressure. As described in detail above, a capacitance fluid level sensor (not illustrated in FIG. 5) is configured to determine the fluid level in riser tube 286, which corresponds to the fluid level in fresh water reservoir 280.

As shown in FIG. 5, a pump 284 is preferably positioned between and/or operatively connects the fresh water reservoir 280 and the boiler 292. A fill tube 288 preferably fluidly connects the pump 284 to the boiler 292. The pump 284 is not limited to being a certain type of pump, as the pump 284 may be a positive displacement pump, a water pump, or an air pump, for example. The pump 284 preferably forces liquid from the outlet 281 of the fresh water reservoir 280 into the boiler 292. A check valve 290 prevents liquid from flowing from the boiler 292 toward the fresh water reservoir 280. The pump 284 can dispense or pump a user-chosen volume of liquid (e.g., small, medium or large) as determined by a time-based algorithm that varies depending on the initial level of water in the fresh water reservoir, as discussed in detail above.

The pump 284 pumps the user-chosen volume of liquid into the boiler 292. Solenoid vent valve 298 is open during this time. Once the user-chosen volume of water is pumped into the boiler 292, the brew or heat cycle is then activated to brew/heat the entirety of the fluid in the boiler 292. Solenoid vent valve 298 is closed during this time. Once the fluid in the boiler 292 reaches the desired temperature, air pump 296 activates to force the hot fluid out of the boiler 292. Because check valve 290 prevents the hold liquid from flowing toward the fresh water reservoir 280, the air pump forces the hot liquid up the riser tube 294 toward discharge port 242. The pressure in the boiler 292 pushes liquid from the boiler 292 through the discharge check valve 266, the discharge port 242 and the container 254 (through hole 245) and into the vessel to be consumed by the user.

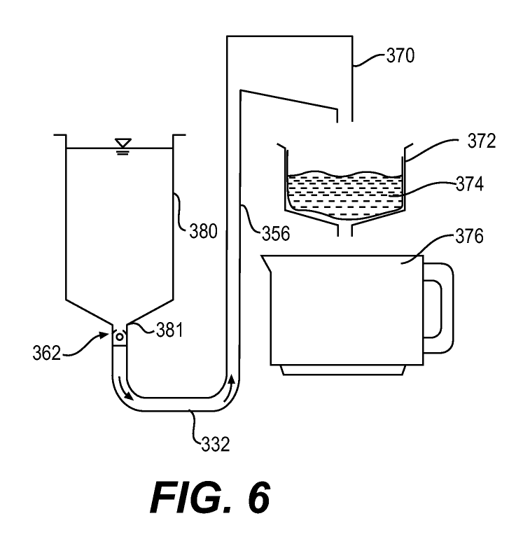

Referring now to FIG. 6, a kitchen appliance is illustrated that is capable of operating in a non-pressurized (i.e., drip brew) mode. The kitchen appliance of FIG. 6 comprises a fresh water reservoir 380 and an outlet 381 formed in a lower portion thereof. At least a portion of a bottom wall of the fresh water reservoir 380 may be slanted or sloped to direct liquid (e.g., water) toward the outlet 381. While it is preferred that the fresh water reservoir 380 is a generally closed container that is separable from the housing of the kitchen appliance, the fresh water reservoir 380 need not be air-tight, such that the fresh water reservoir 380 is maintained at atmospheric pressure. Unlike the kitchen appliance of FIG. 4, the kitchen appliance of FIG. 6 does not include a pump to move fresh water from the fresh water reservoir 380.

The outlet 381 of the fresh water reservoir 380 is fluidly connected to a hot water generator (HWG) 332 through an inlet check valve 362 such that fluid may be transmitted from the fresh water reservoir 380 to the HWG 332 but not vice versa. The HWG 332 is fluidly connected with a riser tube 356, which is in turn fluidly connected with a showerhead 370.

Prior to a brewing cycle, gravity will cause fluid to flow from the fresh water reservoir 380 into the HWG 332 and up the riser tube 356 until the fluid level in the riser tube 356 corresponds to the fluid level in the fresh water reservoir 380. As described in detail above, a capacitance fluid level sensor (not illustrated in FIG. 6) is configured to determine the fluid level in riser tube 356, which corresponds to the fluid level in fresh water reservoir 380.

The brew or heat cycle is activated by energizing the HWG 132 by a relay controlled by the controller 16. The HWG 332 would be energized for a specific period of time dependent on the information from the capacitance sensor on the riser tube 356. The HWG 332 heats the liquid within the system and generates saturated gas bubbles. The gas bubbles increases the pressure of the liquid within the HWG 332 and act to move heated liquid within the HWG 332. Since the inlet check valve 362 prevents liquid from moving out of the HWG 332 and back into the fresh water reservoir 380, heated liquid is forced out of the HWG 332, up the riser tube 356, and into the showerhead 370. From the showerhead 370, the heated liquid drips down onto coffee grounds 374 in the filter basket 372. Heated liquid infused by the coffee grounds exits the filter basket and drips into the cup or carafe 376.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. A beverage maker comprising:
a reservoir for holding a variable volume of a fluid;
a pump for pumping the fluid out of the reservoir;
a fluid-level sensor; and
a controller operatively connected to the pump and the sensor;
wherein, the controller is configured for determining via the sensor, a level of fluid in the reservoir at an initial time; and
wherein the controller is further configured for causing the pump to operate for any one of a plurality of different amounts of time to pump a volume of water, each of the plurality of different amounts of time corresponding to a different level of fluid in the reservoir at the initial time.

2. The beverage maker of claim 1, wherein determining a level of fluid in the reservoir at an initial time comprises determining which one of a plurality of predefined ranges of fluid levels the level of fluid in the reservoir falls within at the initial time.

3. The beverage maker of claim 1, further comprising:
a riser tube in fluid communication with the reservoir such that a level of the fluid in the riser tube corresponds to a level of the fluid in the reservoir;
wherein the controller and sensor determine the level of fluid in the reservoir by determining the level of fluid in the riser tube.

4. The beverage maker of claim 3, wherein the sensor comprises a capacitive sensor affixed to the riser tube, the capacitive sensor comprising at least a pair of spaced apart capacitive plates affixed to opposing sides of the riser tube.

5. The beverage maker of claim 4, wherein the controller is further configured for determining a time to charge the capacitive sensor and/or a time to discharge the capacitive sensor; and
wherein the time to charge the capacitive sensor and/or the time to discharge the capacitive sensor correspond to a level of fluid in the riser tube.

6. The beverage maker of claim 4, wherein the controller is further configured for determining a time to perform a plurality of charge/discharge cycles of the capacitive sensor; and
wherein the time to perform the plurality of charge/discharge cycles of the capacitive sensor correspond to a level of fluid in the riser tube.

7. The beverage maker of claim 4, wherein the controller is further configured for determining a time to perform a plurality of charge/discharge cycles of the capacitive sensor; and
wherein an average of the time to perform the plurality of charge/discharge cycles of the capacitive sensor corresponds to a level of fluid in the riser tube.

8. The beverage maker of claim 4, wherein the controller is further configured for determining a time to perform each of a plurality of groups of charge/discharge cycles of the capacitive sensor, each of the plurality of groups comprising a plurality of charge/discharge cycles of the capacitive sensor; and
wherein an average of the time to perform each of the plurality of groups of charge/discharge cycles of the capacitive sensor corresponds to a level of fluid in the riser tube.

9. The beverage maker of claim 4, wherein the controller is further configured for determining a capacitance of the capacitive sensor; and
wherein the capacitance of the capacitive sensor corresponds to a level of fluid in the riser tube.

10. The beverage maker of claim 4, wherein the controller is further configured for determining a capacitance of the capacitive sensor a plurality of times; and
wherein an average of the capacitance of the capacitive sensor determined a plurality of times corresponds to a level of fluid in the riser tube.

11. A beverage maker comprising:
a reservoir for holding a variable volume of a fluid;
a pump for pumping the fluid out of the reservoir;
a fluid-level sensor; and
a controller operatively connected to the pump and the sensor;
wherein, the controller is configured for determining, in conjunction with the sensor, a level of fluid in the reservoir at an initial time;
wherein the controller is further configured for causing the pump to operate for a first amount of time in order to pump a desired selected volume of water when the level of fluid in the reservoir at the initial time comprises a first initial level; and
wherein the controller is further configured for causing the pump to operate for a second amount of time different than the first amount of time in order to pump the desired selected volume of water when the level of fluid in the reservoir at the initial time comprises a second initial level different than the first initial level.

12. The beverage maker of claim 11, wherein the controller is further configured for causing the pump to operate for a third amount of time different than the first amount of time and different than the second amount of time in order to pump the desired volume of water when the level of fluid in the reservoir at the initial time comprises a third initial level different than the first initial level and different that the second initial level.

13. The beverage maker of claim 11, wherein determining a level of fluid in the reservoir at an initial time comprises determining which one of a plurality of predefined ranges of fluid levels the level of fluid in the reservoir falls within at the initial time.

14. The beverage maker of claim 11, further comprising:
a riser tube in fluid communication with the reservoir such that a level of the fluid in the riser tube corresponds to a level of the fluid in the reservoir;
wherein the controller and sensor determine the level of fluid in the reservoir by determining the level of fluid in the riser tube.

15. The beverage maker of claim 14, wherein the sensor comprises a capacitive sensor affixed to the riser tube, the capacitive sensor comprising at least a pair of spaced apart capacitive plates affixed to opposing sides of the riser tube.

16. The beverage maker of claim 15, wherein the controller is further configured for determining a time to charge the capacitive sensor and/or a time to discharge the capacitive sensor; and
wherein the time to charge the capacitive sensor and/or the time to discharge the capacitive sensor correspond to a level of fluid in the riser tube.

17. The beverage maker of claim 15, wherein the controller is further configured for determining a time to perform a plurality of charge/discharge cycles of the capacitive sensor; and
wherein the time to perform the plurality of charge/discharge cycles of the capacitive sensor correspond to a level of fluid in the riser tube.

18. The beverage maker of claim 15, wherein the controller is further configured for determining a time to perform a plurality of charge/discharge cycles of the capacitive sensor; and
wherein an average of the time to perform the plurality of charge/discharge cycles of the capacitive sensor corresponds to a level of fluid in the riser tube.

19. The beverage maker of claim 15, wherein the controller is further configured for determining a time to perform each of a plurality of groups of charge/discharge cycles of the capacitive sensor, each of the plurality of groups comprising a plurality of charge/discharge cycles of the capacitive sensor; and
wherein an average of the time to perform each of the plurality of groups of charge/discharge cycles of the capacitive sensor corresponds to a level of fluid in the riser tube.

20. The beverage maker of claim 15, wherein the controller is further configured for determining a capacitance of the capacitive sensor; and
wherein the capacitance of the capacitive sensor corresponds to a level of fluid in the riser tube.

21. The beverage maker of claim 15, wherein the controller is further configured for determining a capacitance of the capacitive sensor a plurality of times; and
wherein an average of the capacitance of the capacitive sensor determined a plurality of times corresponds to a level of fluid in the riser tube.

22. A method of pumping a desired volume of fluid from a reservoir of a beverage maker, the method comprising:
determining a level of fluid in the reservoir at an initial time; and
operating a pump for any one of a plurality of different amounts of time to pump a volume of water from the reservoir, each of the plurality of different amounts of time corresponding to a different level of fluid in the reservoir at the initial time.

23. The method of claim 1, wherein determining a level of fluid in the reservoir at an initial time comprises determining which one of a plurality of predefined ranges of fluid levels the level of fluid in the reservoir falls within at the initial time.

24. The method of claim 23, wherein determining a level of fluid in the reservoir comprises determining a level of fluid in a riser tube that is in fluid communication with the reservoir such that a level of the fluid in the riser tube corresponds to a level of the fluid in the reservoir.

25. The method of claim 24, further comprising:
determining a time to charge a capacitive sensor affixed to the riser tube and/or a time to discharge the capacitive sensor;
wherein the time to charge the capacitive sensor and/or the time to discharge the capacitive sensor correspond to a level of fluid in the riser tube.

26. The method of claim 24, further comprising:
determining a time to perform a plurality of charge/discharge cycles of a capacitive sensor affixed to the riser tube;
wherein the time to perform the plurality of charge/discharge cycles of the capacitive sensor correspond to a level of fluid in the riser tube.

27. The method of claim 24, further comprising:
determining a time to perform a plurality of charge/discharge cycles of the capacitive sensor;
wherein an average of the time to perform the plurality of charge/discharge cycles of the capacitive sensor corresponds to a level of fluid in the riser tube.

28. The method of claim 24, further comprising:
determining a time to perform each of a plurality of groups of charge/discharge cycles of a capacitive sensor affixed to the riser tube, each of the plurality of groups comprising a plurality of charge/discharge cycles of the capacitive sensor;
wherein an average of the time to perform each of the plurality of groups of charge/discharge cycles of the capacitive sensor corresponds to a level of fluid in the riser tube.

29. The method of claim 24, further comprising:
determining a capacitance of a capacitive sensor affixed to the riser tube;
wherein the capacitance of the capacitive sensor corresponds to a level of fluid in the riser tube.

30. The method of claim 24, further comprising:
determining a capacitance of a capacitive sensor affixed to the riser tube a plurality of times;
wherein an average of the capacitance of the capacitive sensor determined a plurality of times corresponds to a level of fluid in the riser tube.
